(19) United States
(12) Patent Application Publication
(10) Pub. No.: US 2022/0396194 A1
(43) Pub. Date: Dec. 15, 2022

(54) Box And Assembly For Transporting Livestock And Agricultural Products, And Method

(71) Applicant: Veit Electronics, s.r.o., Brno (CZ)

(72) Inventor: Petr Veit, Brno (CZ)

(21) Appl. No.: 17/835,078

(22) Filed: Jun. 8, 2022

(30) Foreign Application Priority Data
Jun. 14, 2021 (CZ) PV2021-302

(51) Int. Cl. B60P 3/04; B60H 1/00

(52) U.S. Cl. CPC B60P 3/04; B60H 1/00014

(57) ABSTRACT

A transport container for transporting livestock and/or agricultural products is disclosed. The transport container is releasably connected with a box comprising an open connecting side, at which the box is provided with anchor parts. The box contains an inlet opening for supplying fresh air, wherein an air conditioning device is arranged in the box and is connectable to the inlet opening for fresh air supply into the air conditioning device. The open connecting side of the box contains a region, in which an air outlet from the air conditioning device is arranged and is in fluid communication with an intake opening in the container, and a re-entry opening which is for re-entry of air from the container and which is fluidly connectable with intake of the air conditioning device.

### FIELD OF INVENTION

The present invention relates to a box and to an assembly comprising the box and a transport container for transporting livestock, particularly poultry, e.g. day-old chickens, as well as agricultural products, e.g. hatching eggs. The invention also relates to a method of transporting of agricultural products.

### BACKGROUND ART

Vehicles and containers for transporting livestock, including day-old chickens, are known in the art. For transporting livestock and agricultural products, such vehicles must be equipped accordingly—particularly, they have to have a proper air-conditioning system for maintaining sufficient level of oxygen in the air in the cargo space, and a temperature suitable for given type of livestock. In such known vehicles, machinery for cleaning and supplying air into the cargo space is located directly in the cargo space, so that maintenance of the container and manipulation therewith time consuming and available area inside the container for holding the livestock is thus reduced.

For example, Russian utility model RU68980U1 discloses a vehicle for transporting chickens and hatching eggs. The vehicle also contains an isothermal container provided with an air-conditioning system; the system being located inside the container.

Chinese utility model CN211844021U discloses an air-conditioning unit for livestock transport vehicle, said air-conditioning unit being provided inside the transport container space.

U.S. Pat. No. 3,551,008 discloses a vehicle provided with a small refrigeration conditioning unit outside the cargo space. However, the refrigeration unit does not allow for recirculation of air, the unit does not contain any apparatus for cleaning the air, nor any dedicated power supply.

KR100366313 discloses a similar vehicle, the air conditioning unit is not easily removable, and parts of the machinery for air disinfection are arranged at the lower side of the vehicle. Thus, the whole vehicle must be put out of service, when maintenance of the air conditioning and disinfection unit is needed.

KR20160097931 discloses a vehicle containing a cargo space for transporting livestock. The cargo space contains a partition, which divides the cargo space in a machinery room with air conditioning unit, and a transport room. The partition contains openings for feeding conditioned air into the transport room and openings for returning used air from the transport room into the machinery room, i.e. to the air conditioning unit. However, mixing of outside air and used air cannot be regulated easily. Also, when the machinery in the machinery room needs maintenance, the whole vehicle is set out of service.

### SUMMARY OF THE INVENTION

The above drawbacks of prior art are eliminated by a box comprising a bottom and a ceiling, two mutually opposing side walls, a transversal wall and a thereto opposing open connecting side, at which the box is provided with anchor parts for releasable connection with a transport container for transporting livestock and/or agricultural products. The box contains an inlet opening for supplying fresh air, wherein an air conditioning device is arranged in the box, said air conditioning device being connectable to said inlet opening for fresh air supply into the air conditioning device. The open connecting side of the box contains a region, in which an air outlet from the air conditioning device is arranged, and a re-entry opening which is fluidly connectable with intake of the air conditioning device.

The drawbacks are also eliminated by an assembly containing a transport container comprising an open connecting side, the container being for transporting livestock and/or agricultural products, wherein the container is connectable or releasably connected with a box comprising open connecting side, at which the box is provided with anchor parts,

the box containing an inlet opening for supplying fresh air,

wherein an air conditioning device is arranged in the box, said air conditioning device being connectable to said inlet opening for fresh air supply into the air conditioning device,

wherein the open connecting side of the box contains

a region, in which air outlet from the air conditioning device is arranged and is in fluid communication with an intake opening in the container, and

a re-entry opening which is for re-entry of air from the container and which is fluidly connectable with intake of the air conditioning device.

Further preferred features of the invention are disclosed in the dependent claims and more specifically in following description.

### BRIEF DESCRIPTION OF THE DRAWINGS

Preferred exemplifying embodiments are described below with references to drawings, wherein:

FIG. 1 schematically depicts a cross-section of an inventive assembly of a box and a (partially depicted) transport container in a first mode of operation,

FIG. 2 similarly schematically depicts a cross section of the assembly in a second mode of operation,

FIG. 3 schematically depicts a front view of the box, wherein a part of a door is removed,

FIG. 4 schematically depicts a perspective view of the box with the transport container,

FIG. 5 schematically depicts an example of an anchor part,

FIG. 6 schematically depicts an embodiment of a pair of anchor parts mutually connected by a connection part.

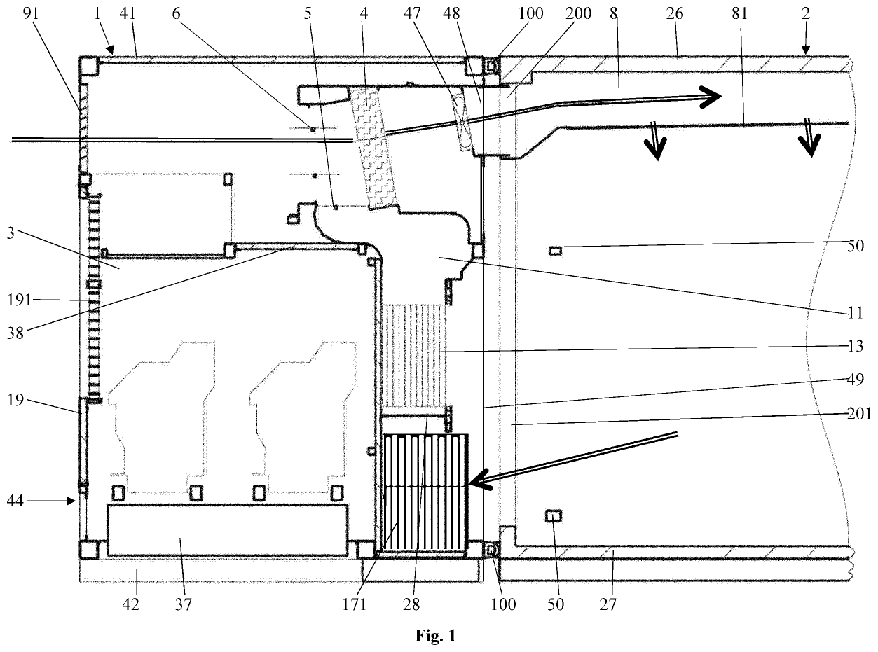

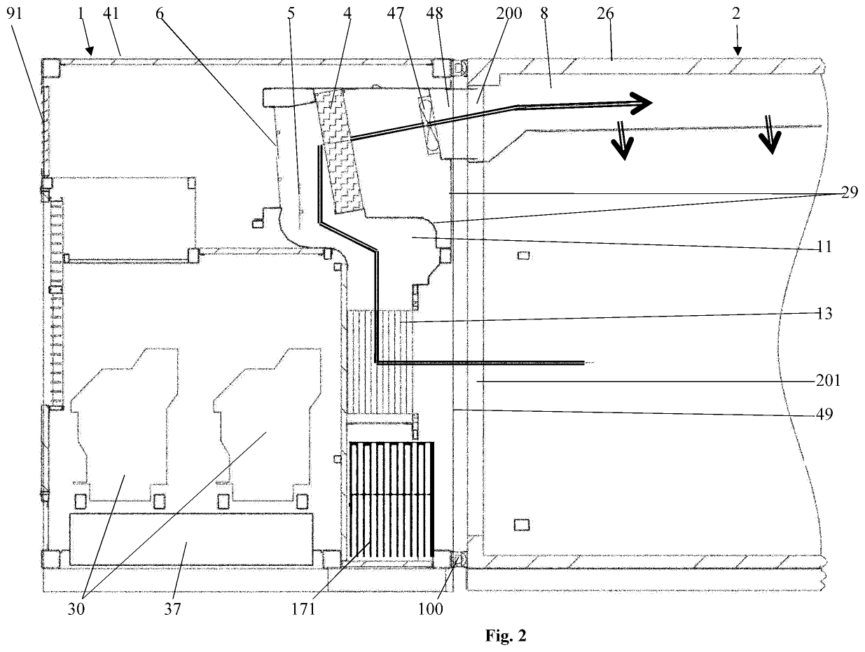

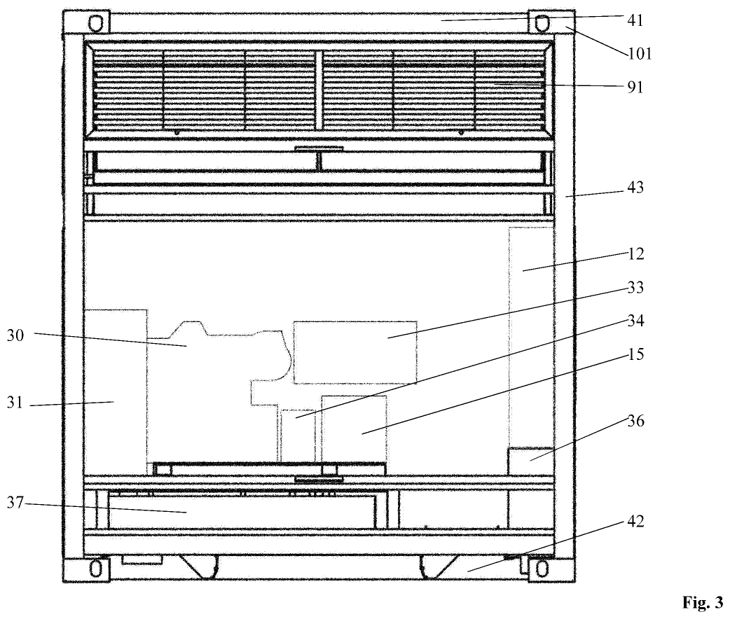

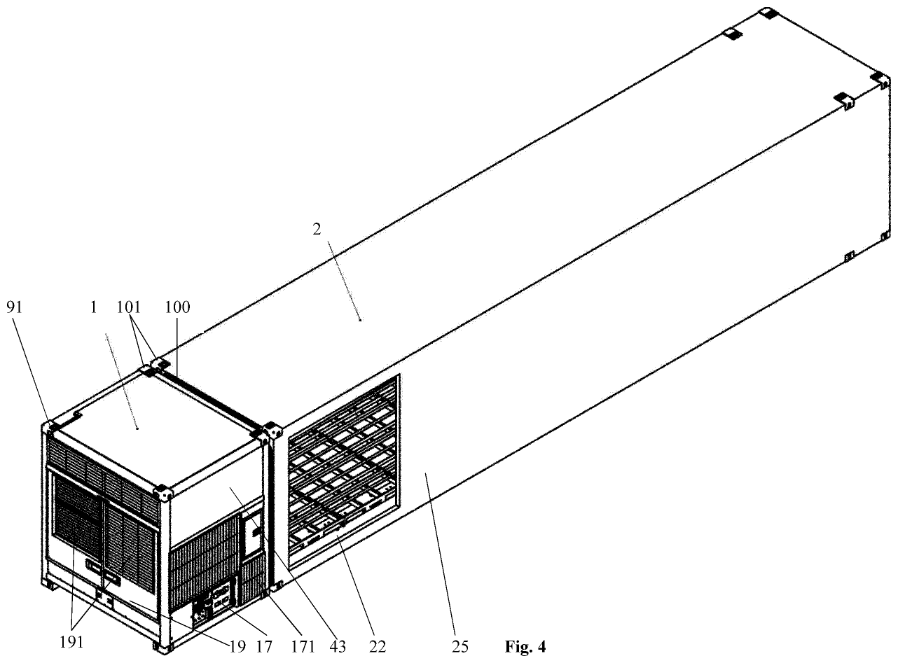

### PREFERRED EMBODIMENTS OF THE INVENTION

An exemplifying embodiment of the present invention is a box 1, which is intended for being connected to a transport container 2 for transporting day-old chickens. The term “transport container” in this application indicates any of the following: container, cover of transport/cargo space, transport box, trailer.

The box 1 has a ceiling 41 and a bottom 42 arranged opposite to the ceiling 41, a pair of mutually opposing side walls 43 and a transversal wall 44 arranged in a plane perpendicular to the bottom 42, ceiling 41 and side wall 43. The box 1 is open at its connecting side, which is opposite to the transversal wall 44, and which is provided with a sealing 100 along its outer circumference. According to another embodiment, the box 1 can contain a partial (not across the entire surface) baffle and openings at the side opposed to the transversal wall 44, the openings providing connection to the air distribution lines in the transport container 2, as will be described below.

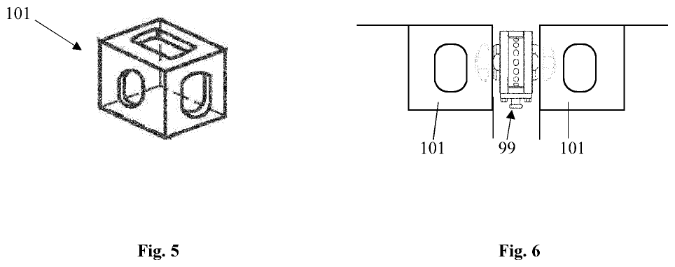

At the connecting side, the corners of the box 1 are provided with corner anchor parts 101, which, in this embodiment, have an opening on the connecting side of the box 1 and on the ceiling and/or lateral side, the openings being intended for insertion and control of connection parts 99 when connecting the box 1 to the transport container 2. These corner anchor parts can be common corner anchor parts (shown in FIG. 5), used for connecting containers, e.g. in accordance with the standard ISO 1161:1984, e.g. for connecting by a connecting part 99 of the “twist lock” type (as indicated in FIG. 6). Other anchor parts 101 and connecting parts 99 can be used as well, particularly those that allow for a dismountable coupling of the box 1 and the transport container 2 so that their internal spaces are mutually connected.

The transport container 2 has mutually parallel side panels 25, mutually parallel ceiling wall 26 and bottom wall 27, and an end wall (not shown), which is perpendicular to the side panels 25 and the ceiling and bottom walls 26, 27 and which preferably contains (not shown) an access door for access to and/or loading of the transport container 2. At a side opposed to the end wall, i.e. at its connecting side, the transport container 2 is open or can alternatively contain a partial (not extending across the entire area) wall with openings for inter connection with the air distribution inlets and outlets of the box 1.

Under the ceiling of the transport container 2, an air distribution channel 8 is provided, the air distribution channel 8 being intended for distributing conditioned air into internal space of the transport container 2 across its entire length. In this embodiment, the air distribution channel 8 is formed by soffits 81, which are fixed under the ceiling wall 26 and contain pass-through openings for passage of air.

The transport container 2 can further contain internal side bars for fastening of the cargo and sensors for temperature monitoring and/or sensors for humidity monitoring and/or sensors for monitoring of CO₂ levels. Additionally or alternatively, the temperature monitoring sensors and/or the humidity monitoring sensors and/or the sensors for monitoring of CO₂ levels or some of them may be installed in the trajectory of air in the box 1. These sensors are, regardless of their location, preferably connectable (using cables or wirelessly) to the control unit in the box 1 for communicating/transmitting measured values, and connectable electrically to a power distribution board 36 for ensuring power supply for the sensors.

The box 1 has a circumferential ledge at its connecting side, the contour of which corresponds to the contour of a circumferential ledge of the connecting side of the transport container 2, while the sealing 100 is fixed to one of these circumferential ledges and is compressed between these circumferential ledges, when the box 1 and the transport container 2 are mutually connected. In other words, the circumferential sealing 100 is arranged, i.e. clamped between the box 1 and the transport container 2, said sealing being preferably fixed to the box 1 at its connecting side and the sealing 100 seals the connection along a circumference of the interface between the connecting side of the box 1 and the connecting side of the transport container 2 when the box 1 and the transport container 2 are mutually connected.

Furthermore, the box 1 contains a control unit, which is operable and controllable by means of a control panel 17 disposed e.g. at a side wall 43 of the box 1.

The box 1 has an inlet opening in the transversal wall 44, said inlet opening being intended for inlet of fresh air into the box 1. The inlet opening is covered by an obliquely tilted covering shutter 91, the rails of said shutter extending parallelly to each other and being spaced apart, i.e., to delimit longitudinal, mutually parallel passages and to prevent entry of raindrops into the box 1.

The inlet opening leads into an entry space inside the box 1, said inlet space being in fluid communication with an intake of an air-conditioning device, i.e. into an evaporator 4 in the present embodiment, the outlet of which is in fluid communication with an air outlet 48 at the connecting side of the box 1, wherein the air outlet 48 of the box 1 is connected/connectable to a feed opening 200 into the air distribution channel 8 at the connecting side of the transport container 2.

Furthermore, a heating device (not shown) is arranged in the box 1, said heating device forming a part of the evaporator 4, or it is arranged (similarly to the evaporator 4) in the trajectory of the air between the entry space and the air outlet 48 of the box 1 and it is intended for heating air when needed. Alternatively, a heater can be used as an air-conditioning device (without a cooling device, i.e. without the evaporator 4 and the corresponding components).

The box 1 comprises a passage from the entry space into an intake of the evaporator 4, the passage is closable by fresh air flaps 6 arranged for selectively preventing or allowing entry of outside/fresh air into the box or rather entry of air from the entry space into the evaporator 4. The fresh air flaps 6 are preferably controllable by a control unit and/or are electrically connected to the power distribution board 36.

A ventilator 47, or better a set of ventilators 47 arranged side by side along the ceiling 41 of the box 1, is/are arranged between the air outlet of the evaporator 4 and the air outlet at the connecting side of the box 1.

A filter (not shown) may be arranged in the region between the evaporator 4 and the ventilator 47 or between the covering shutter 91 and the evaporator 4, wherein said filter may be e. g. in the form of a set of replaceable filters or in the form of a filter having a replaceable textile filler.

The connecting side of the box 1 is further provided with a re-entry opening 49 for passage of air from the transport container 2 back to the box 1. The re-entry opening 49 can be formed e. g. by a free space at the connecting side of the box 1 under the air outlet 48.

A runoff opening 201 is arranged under the feed opening 200 at the connecting side of the transport container 2, said runoff opening being aligned with the re-entry opening 49 at the connecting side of the box 1. The box 1 also contains a baffle 29 which separates the air outlet 48 from the re-entry opening 49.

The area of the re-entry opening 49 in the plane of the connecting side of the box 1 corresponds to at least 30%, preferably to at least 40%, most preferably to at least 50% of the area of the connecting side to the box 1.

Similarly, the area of the runoff opening 201 at the connecting side of the transport container 2 corresponds to at least 30%, preferably at least 40%, most preferably at least 50% of the area of the connecting side of the transport container 1.

The re-entry opening 49 in the box 1 is in fluid communication with a side discharge window in the side wall of the box 1, said side discharge window being covered by mutually parallel flat tilt bars 171, wherein the degree of opening of the discharge window is regulated by tilting of the tilt bars 171.

The re-entry opening 49 in the box 1 is in fluid communication with a recirculation channel 11, inside of which a recirculation flap 5 is arranged, wherein the recirculation flap 5 is adapted to selectively close or open the recirculation channel 11, thereby connecting/disconnecting the re-entry opening 49 with the air intake into the evaporator 4 or rather into the air conditioning device.

A filter 13 for filtration of the recirculated air is arranged inside the recirculation channel 11 or rather between the re-entry opening 49 and the recirculation flap 5. A partition 28 is arranged between the filter 13 and the space adjacent to the discharge window.

Furthermore, the box 1 contains a machinery space 3, the machinery according to the present embodiment comprising a pair of internal combustion engines 30, a pair of coolers 31 for the combustion engines 30, a pair of electromotors 33, alternators 34, a power distribution board 36 and a fuel tank 37 which connects the components to produce electrical energy, to feed electrical current to the power distribution board 36 and for driving the cooler compressor. Electrical current can be than used for power supply of the individual components in the box 1 (particularly the ventilators, the control unit and the flaps 5, 6, the tilt bars 171, a closable shutter 191 and other components controlled by the control unit) as well as in the transport container 2.

In alternative embodiments one electromotor 33 can be used or one electrical accumulator.

The fuel tank 37 is located near the bottom of the box 1.

The machinery space 3 of the box 1 further contains a condenser 12 and a compressor 15 which is driven by the internal combustion engine 30. The condenser 12 is connected with the evaporator 4 and ensures cooling of the evaporator 4 body when needed in order to cool the air passing through the evaporator 4 (i. e. passing along the individual components of the evaporator 4 body).

Access to the machinery space 3 is enabled by a service door 19, in the present embodiment in the form of a double door with vent openings, which are covered by a closable shutter 191, which allows for opening and closing of the vent openings.

The machinery space 3 is separated from the other parts of the box space by a dividing wall 38.

When in use, while the box 1 and the transport container 2 are connected, the box 1 may provide the following functions:

In a first mode (according to the present invention a mode of supplying fresh air from the surrounding environment) ram air or generally fresh air flows through the cover shutter 91, wherein the fresh air flaps 6 are open so that the air enters the entry space through the inlet opening of the box 1, further flows through the air conditioning device or a heat exchanger, said heat exchanger being an evaporator 4 (eventually also a heater) according to the present embodiment, wherein the temperature of the passing air is adjusted to a desired value and such adjusted air flows through the air outlet 48 and through the feed opening 200 into the air distribution channel 8. From the air distribution channel 8, the air passes through the internal space of the transport container 2 to the transported livestock through openings in the soffits 81. The used air subsequently returns through the runoff opening 201 of the transport container 2 and the aligned re-entry opening 49 into the box 1, from which the air can be discharged via the side discharge window which is opened by a suitable tilting of the discharge tilt bars 171. The recirculation flap 5 is closed so that the air fed into the box 1 by the re-entry opening 49 does not enter the evaporator 4, it does not get into the air outlet 48 again.

In a second mode (according to the present embodiment a recirculation mode) the fresh air flaps are closed while the recirculation flap 5 is open. The used air returning from the transport container 2 via the runoff opening 201 of the transport container 2 and the aligned re-entry opening 49 into the box 1 is lead through the filter 13 into the recirculation channel 11 and further to the evaporator intake, passes through the evaporator 4 and further through the air outlet 48 and the feed opening 200 to the air distribution channel 8.

Both modes can be combined by an appropriate partial opening/closing of the flaps 5, 6 and if required also by partial opening/closing of the tilt bars 171 for opening/closing of the discharge window.

Suitably arranged sensors measure the temperature of the air fed into the air distribution channel 8 and/or inside the transport container 2 and other values, and the flaps 5, 6 and/or tilt bars 171 and/or ventilators 47 and/or the operation of the compressor 15 and evaporator 4 or heater, eventually other air conditioning devices, are controlled by the control unit based on measured values. However, each of said components may be designed such that it can be operated manually when needed.

The box 1 is preferably located behind a cargo truck driver's cabin (not shown), the cargo truck being intended for transport of the transport container 2, i.e. between the driver's cabin and the transport container 2, preferably so that the transversal wall 44 with an inlet opening is oriented in the travel direction, i.e. it is closest to the driver's cabin.

The inlet opening can be arranged additionally or alternatively in the ceiling 41 and/or the side walls 43 of the box 1, wherein the ram air is fed into the box 1 by appropriately tilting regulation bars covering these additional or alternative inlet openings.

The discharge window for discharging used air from the box 1 can be alternatively arranged in the ceiling 41 or in the bottom 42 of the box 1.

Livestock can be placed e. g. in suitable crates inside the transport container 2.

In the present embodiment, the transport container 2 also comprises unloading opening 22 for unloading cargo, wherein said unloading opening 22 is located in the side wall of the transport container 2 and provided with unloading door (not shown). Alternatively, a transport container without such an unloading opening can be used.

The box 1 may be provided with stop elements 50, which protrude into the transport container 2 space in the connecting side region and serve as a stopper for the cargo and/or crates. The stop elements 50 may be in the form of tubes or bars which extend in the horizontal direction and their ends are bent and fixed to the walls of the box 1. A reel may be also arranged in the box 1, said reel being manually or power driven and having a rope for pulling the cargo from an entry door of the transport container 2 to its connecting side, or to the stop elements 50.

The box 1 and the transport container 2 are made to be fixed to a chassis of a truck tractor, of a truck, or of a semi-trailer. In a preferred embodiment, the transport container 2 is fixedly and irremovably attached to the chassis. The box 1 is dismountably attached to the transport container 2 and additionally it may also be dismountably attached to the chassis. The control unit may include an electronic device, which is connectable to the control unit wirelessly or by wire, the electronic device allowing the driver to monitor and/or control the operation of the control unit or individual components of the box 1.

Thanks to the fact that the box 1 with the entire air conditioning equipment is quickly and easily disconnectable from the transport container 2 or connectable to the transport container 2, situations when maintenance or repair of the machinery in the box 1 is needed, and/or when a disinfection of the transport container 2 cargo space is needed in another time, can be expeditiously resolved. The shipper can thus, when needed, disconnect and remove one box 1 from the vehicle for maintenance of the equipment within the box 1 and load onto the vehicle and connect to the transport container 2 another box. The stress resulting from coordination of requirements for arrival and departure with the cargo and requirements for maintenance and refueling the internal combustion engines 31, for checking and replacement of the air conditioning elements etc., is thus significantly relieved. The shipper of agricultural products may purchase low-expense transport containers 2, and rent the box(es) 1 with air conditioning equipment as needed. Eventually, the shipper can, apart from the transport containers 2 (and eventually the boxes 1), possess an additional wall attachable at the connecting side to the transport container 2, when transport container 2 is to be used for transporting another type of cargo as well (cargo which does not require use of the box 1).

The exemplifying embodiment is described with regard to the transport container 2. Another types of transport containers can be used, e. g. a separate trailer. Such transport container is adapted for transporting livestock, e. g. poultry, or agricultural products, e. g. hatching eggs.

The exemplifying embodiment is described particularly with regard to air temperature adjustment, but the oxygenation/CO₂ level in the air can be alternatively or simultaneously adjusted, particularly by controlling the amount of fresh air fed from the exterior of the box 1 and the amount of the recirculated air from the transport container 2.

It is clear that a person skilled in the art would readily find further possible alternatives to the embodiments described herein. The scope of the protection is therefore not limited to these exemplifying embodiments but it is rather defined by the appended claims.

1. A box comprising a bottom and a ceiling, two mutually opposing side walls, a transversal wall and a thereto opposing open connecting side, at which the box is provided with anchor parts for releasable connection with a transport container for transporting livestock and/or agricultural products,
the box containing an inlet opening for supplying fresh air,
wherein an air conditioning device is arranged in the box, said air conditioning device being connectable to said inlet opening for fresh air supply into the air conditioning device,
wherein the open connecting side of the box contains
a region, in which air outlet from the air conditioning device is arranged, and
a re-entry opening which is fluidly connectable with an intake of the air conditioning device.

2. The box according to claim 1, wherein the box has a circumferential ledge at its connecting side and a circumferential sealing fixed to the circumferential ledge.

3. The box according to claim 2, wherein area of the re-entry opening corresponds to at least 30%, preferably at least 40%, most preferably at least 50% of the area of the connecting side of the box.

4. The box according to claim 1, wherein the inlet opening for supplying fresh air is arranged in the transversal wall.

5. The box according to claim 1, wherein the air conditioning device contains a heater for air heating,
and/or a compressor, a condenser, an evaporator and an expansion valve, which are mutually connected for providing cooling of air passing through the evaporator.

6. The box according to claim 1, wherein the box comprises:
at least one ventilator for forced guiding of the airflow through the air conditioning device into the air outlet, and
a fuel tank and at least one internal combustion engine which are connected mutually and with the ventilator to drive the ventilator or for production of electric current to power supply the air conditioning device and the ventilator.

7. The box according to claim 1, wherein the box comprises a discharge window which is fluidly connected to the re-entry opening and is selectively openable and closable by means of discharge tilt bars.

8. The box according to claim 1, wherein the box comprises:
at least one fresh air flap operable for selective closing and opening of fluid connection between the inlet opening and the intake of the air conditioning device, and/or
at least one recirculation flap operable for selective closing and opening of the fluid connection between the re-entry opening and the intake of the air conditioning device.

9. An assembly for transporting livestock, the assembly comprising:
a box according to claim 1, and
a transport container comprising a ceiling wall, a bottom wall, opposing side panels and an open connecting side by which the transport container faces the connecting side of the box, wherein the box and the transport container are mutually releasably connected,
wherein the connecting side of the transport container has a circumferential ledge and the connecting side has a circumferential ledge, the contour of which corresponds to the contour of the circumferential ledge of the connecting side of the transport container.

10. The assembly according to claim 9, wherein the transport container comprises a distribution channel for distribution of conditioned air in the transport container, wherein the air outlet of the air conditioning device leads into an intake opening of the distribution channel and the transport container is provided with a runoff opening at the connecting side, the runoff opening being fluidly connected with the re-entry opening of the box.

11. The assembly according to claim 9, wherein the circumferential ledge of the connecting side of the transport container and the circumferential ledge of the connecting side of the box abut each other directly or via a sealing, when the box and the transport vehicle are connected to each other.

12. A method of feeding conditioned air into a transport container for transporting livestock and/or agricultural products, wherein the method comprises:
preparation of a transport container for transporting livestock and/or agricultural products which has an open connecting side and a distribution channel for distributing air in the transport container,
preparation of a box having an open connecting side, the circumferential ledge of which is complementary to the circumferential ledge of the connecting side of the transport container, wherein the box comprises an air conditioning device,
connection of the box with the transport container by a releasable connection so that the connecting side of the transport container and the connecting side of the box are adjacent to each other, wherein an air outlet for conditioned air leads into an intake of the distribution channel at the connecting side of the box,
feeding air to the air conditioning device in the box, the air being subsequently lead into the distribution channels, into the internal space of the transport container via openings in the distribution channel, and
return of at least a part of air from the transport container into the box via a re-entry opening in the connecting side of the box.

13. The assembly according to claim 9, further comprising a chassis, wherein the transport container is attached to the chassis by means of a non-dismountable connection.
